(19) United States
(12) Patent Application Publication
(10) Pub. No.: US 2013/0014794 A1
(43) Pub. Date: Jan. 17, 2013

(54) FOLDABLE TENT

(71) Applicant: Ki Ho Jin, Rongshen New City (CN)

(72) Inventor: Ki Ho Jin, Rongshen New City (CN)

(21) Appl. No.: 13/397,117

(22) Filed: Feb. 15, 2012

(30) Foreign Application Priority Data
Jul. 12, 2011 (CN) 201120244599.5

(51) Int. Cl. E04H 15/46; F16B 1/00; E04H 15/48

(52) U.S. Cl. 135/139; 135/151; 24/595.1

(57) ABSTRACT

A foldable tent having a frame assembly and a cover fixed to the frame assembly such that an enclosed area is provided when the tent is erected in an open configuration, and the frame assembly and cover are collectively compactly collapsed and folded together in a collapsed configuration of the tent. The frame assembly includes a plurality of independent frame members detached from each other. Each frame member has an upper frame member and a pair of side frame members, each comprising a plurality of pole sections. The upper frame member and the pair of side frame members are pivotally coupled together. A connector device pivotally couples a pair of upper frame member pole sections and permits positioning of the pole sections in a substantially aligned locked configuration or in a substantially parallel unlocked configuration.

### BACKGROUND OF THE INVENTION

1. Field of the Invention

The present invention relates to a foldable or collapsible tent, and more particularly to a large tent that can be easily erected to form a secure enclosed area, and easily collapsed and folded to a compact configuration for convenient storage and transport.

2. Description of Prior Art

For novice campers and camping families, among others, foldable tents are a popular alternative to conventional assemble-to-use tents. The cover and frame assembly of foldable tents are permanently attached to each other, i.e., preassembled, and are typically sold with a central hub and a plurality of poles pivotally attached to the hub. These tents are commonly referred to as “instant tents,” “one-touch tents” or “pop-up tents,” and erecting and collapsing the tent is easy and less time consuming than conventional assemble-to-use tents. Instant tents are particularly advantageous for smaller tents because a minimal number of poles, typically four, are required and thus erecting and collapsing the instant tent is quite simple. However, with larger tents, instant tents pose several problems.

For example, more poles as well as a larger cover are required to support larger instant tents and thus erecting, collapsing and folding the instant tent could be challenging to the user. Specifically, the increased number of poles and pole sections requires extra steps to erect and collapse the tent. Moreover, the only method in which the larger instant tents can be folded is by surrounding the larger cover around the entire collapsed frame assembly. Because there is no systematic method of folding larger instant tents, it is difficult to consistently fold the tent into a tight, compact bundle.

As another example, larger components and an increased variety of parts are required to manufacture larger instant tents. For instance, larger parts are required to manufacture the central hub to accommodate the increased number of poles and poles of different lengths must be used to accommodate for the increased length of larger tents. Therefore, the instant tent is bulkier, and for the manufacturer material costs are increased significantly and increased manpower is necessary to assemble the variety of parts.

As a final example, the use of a central hub limits the overall configuration of the instant tent because the overall length of the tent is limited by the length of the poles which can securely extend from the hub. Therefore, a tent with a more elongated configuration cannot be achieved.

### OBJECTS AND SUMMARY OF THE INVENTION

The present invention is intended to overcome at least the above-described disadvantages and to provide a viable alternative to instant tents in the prior art. The objects and advantages of the present invention, more specifically, are to provide a foldable tent that can be manufactured at a relatively low cost and that is also capable of having a more elongated configuration, while maintaining ease in erecting, collapsing and folding the foldable tent as a whole.

For achieving the above-mentioned objects, the present invention provides a foldable tent having a frame assembly and a cover fixed to the frame assembly such that an enclosed area is provided when the tent is erected in an open configuration, and the frame assembly and cover are collectively compactly collapsed and folded together in a collapsed configuration of the tent. The frame assembly includes a plurality of independent frame members detached from each other, each frame member having an upper frame member and a pair of side frame members. Each upper and side frame members have first and second sections, and each first and second section have an inner end and an outer end. The inner ends of the first and second sections of each upper frame member are pivotally coupled together by a lockable first pivotal coupling member. Each outer end of the first and second sections of each upper frame member is pivotally coupled to an outer end of a corresponding side frame member first section by a second pivotal coupling member. The first and second sections of each side frame member are slidingly coupled together. The cover includes a plurality of adjoining cover members fixedly coupled together to form an enclosure having an inner surface and an outer surface. The cover has a top section, a plurality of side sections and a bottom section, and the adjoining cover members form a plurality of seams.

The present invention also provides a connector device for retaining a pair of pivotally connected tent poles. The connector device includes male and female components coupled to one another so as to permit positioning of the poles in a substantially aligned configuration or in a substantially parallel configuration with respect to each pole. The male component includes an outer section having a first cavity for securely receiving an end of one of the poles and an opposing inner section having an inner projection. The inner projection includes an elongated slot having a first end and a second end. The elongated slot extends through the inner projection and an engaging extension extends axially from a center portion of the projection. The female component includes an outer section having a second cavity for securely receiving an end of the other one of the poles and an opposing inner section having a housing for receiving the inner projection of the male component. The housing has an upper portion and two opposing side portions extending downward from the upper portion. The male and female components are pivotally connected together by a fastener extending through the elongated slot of the male component and fixedly coupled to the opposing side portions of the housing of the female component. An upper portion of the housing has an opening for receiving a movable engaging member. A lower section of the engaging member includes a pair of spaced apart extensions thereby forming a channel therebetween. In a locked state the engaging extension of the male component is fixedly secured within the channel of the engaging member of the female component such that the male and female components are maintained in the substantially aligned configuration, and in an unlocked state the engaging extension of the male component disengages the engaging member of the female component to permit displacement and pivoting up to 180 degrees of the male component relative to the female component.

### BRIEF DESCRIPTION OF THE DRAWINGS

FIG. 1 is a perspective view of the foldable tent of the present invention in an open configuration;

FIG. 2 is a perspective view of the foldable tent of FIG. 1 with the frame assembly in a partially collapsed configuration;

FIG. 3 is a perspective view of the foldable tent of FIG. 1 in a first partially folded configuration;

FIG. 4 is a perspective view of the foldable tent of FIG. 1 in a second partially folded configuration;

FIG. 5 is a perspective view of the foldable tent of FIG. 1 in a third partially folded configuration;

FIG. 6 is a perspective view of the foldable tent of FIG. 1 in a fully folded configuration;

FIG. 7 is a side view of a frame member of the foldable tent of FIG. 1 in an open configuration as also shown in FIG. 1;

FIG. 8 is a side view of the frame member of FIG. 7 with the side frame members in a retracted position;

FIG. 9 is a side view of the frame member of FIG. 7 in the partially collapsed configuration shown in FIG. 2;

FIG. 10 is a perspective view of the frame member of FIG. 7 in a fully collapsed configuration as in FIGS. 3-6;

FIG. 11 is a perspective view of an alternative embodiment of a frame member of the present invention;

FIG. 12 is a perspective view of an embodiment of a third pivotal coupling member of the frame member of FIG. 11;

FIG. 13 is a perspective view of another embodiment of a third pivotal coupling member of the frame member of FIG. 11;

FIG. 14 is a perspective view of a second pivotal coupling member of the present invention;

FIG. 15A is a side view of an embodiment of a first pivotal coupling member of the present invention in a locked state;

FIG. 15B is a side view of the first pivotal coupling member of FIG. 15A in an unlocked and partially folded state;

FIG. 16A is an inverted cross-sectional view of the first pivotal coupling member of FIG. 15A;

FIG. 16B is an inverted cross-sectional view of the first pivotal coupling member of FIG. 15A in an unlocked state;

FIG. 16C is an inverted cross-sectional view of the first pivotal coupling member of FIG. 15A in an unlocked and partially folded state;

FIG. 16D is an inverted cross-sectional view of the first pivotal coupling member of FIG. 15A in an unlocked and fully folded state;

FIG. 17 is a side view of an alternative embodiment of a first pivotal coupling member of the present invention in a locked state;

FIG. 18 is a cross-sectional view of the first pivotal coupling member of FIG. 17;

FIG. 19 is a top view of the first pivotal coupling member of FIG. 17;

FIG. 20 is a cross-sectional view of the first pivotal coupling member of FIG. 19;

FIG. 21 is a side view of the first pivotal coupling member of FIG. 17 in an unlocked state;

FIG. 22 is a cross-sectional view of the first pivotal coupling member of FIG. 21;

FIG. 23 is a top view of the first pivotal coupling member of FIG. 21;

FIG. 24 is a cross-sectional view of the first pivotal coupling member of FIG. 23;

FIG. 25 is a side view of the male component of the first pivotal coupling member of FIG. 17;

FIG. 26 is a side view of the female component of the first pivotal coupling member of FIG. 17; and

FIG. 27 is a perspective view of a coupling extension fixed to a bottom section of the cover of the foldable tent of the present invention.

To facilitate an understanding of the invention, identical reference numerals have been used, when appropriate, to designate the same or similar elements that are common to the figures. Further, unless stated otherwise, the features shown in the figures are not drawn to scale, but are shown for illustrative purposes only.

### DETAILED DESCRIPTION OF THE PREFERRED EMBODIMENTS

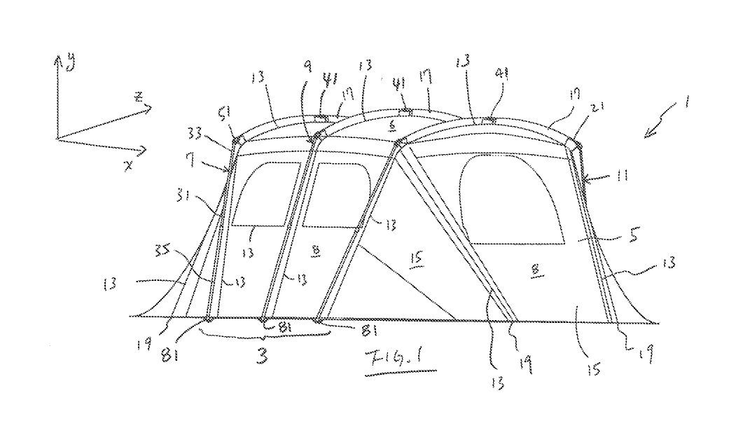

Referring to FIG. 1, a foldable tent 1 of the present invention is shown in a fully open configuration. The foldable tent 1 generally includes a frame assembly 3 and a cover 5 attached to the frame assembly 3. In the preferred embodiment, the frame assembly 3 includes three substantially identical frame members 7, 9, 11—one inner frame member 9 and two outer frame members 7, 11—and each frame member 7, 9, 11 is independent and detached from each other. Manufacturing costs are reduced due to the conformity of parts required for the frame members 7, 9, 11. In the preferred embodiment, each outer frame member 7, 11 is equidistant from the inner frame member 9. The inner frame member 9 is substantially upright while each outer frame member 7, 11 rests at an angle such that the apex of the inner frame member 9 is higher than the apex of the outer frame members 7, 11. The height difference between the inner frame member 9 and the outer frame members 7, 11 forms a decline on a top section of the cover 6, which facilitates a downward run off, thus preventing any accumulation of water or debris on the top section of the cover 6.

One of ordinary skill in the art will recognize that more than three frame members could be included in the frame assembly without departing from the spirit and scope of the present invention. Furthermore, the distance separating the frame members 7, 9, 11 as well as the height difference between the frame members 7, 9, 11 could vary.

Referring to FIGS. 7-10, each frame member 7, 9, 11 includes an upper frame member 21 and a pair of side frame members 31. The upper frame member 21 includes a first pole section 23 and a second pole section 25, and each pole section 23, 25 has an inner end 27 and an outer end 29. In the preferred embodiment, each section 23, 25 is a substantially hollow, tubular pole constructed of reinforced fiberglass for increased flexibility while maintaining strength, but other flexible high-strength materials could be used. The inner ends 27 of the upper frame member first and second sections 23, 25 are pivotally connected together by a lockable first pivotal coupling member or connector device 41.

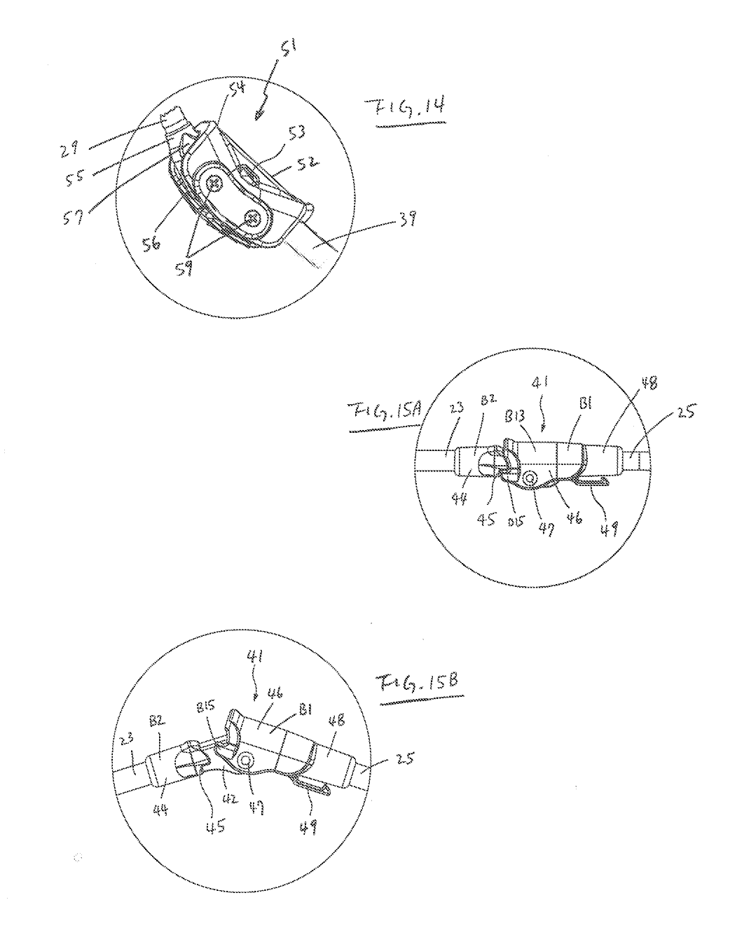

FIGS. 15A-B and 16A-D show an embodiment of the first pivotal coupling member 41. This embodiment of the first pivotal coupling member 41 is described in detail in U.S. Pat. No. 7,942,159 B2 (issued May 17, 2011), which is incorporated herein by reference in its entirety. The first pivotal coupling member 41 includes a female component B1 and a male component B2. The female and male components B1, B2 are preferably formed of a tough, molded plastic but can also be constructed with other high-strength, light-weight materials and by other methods without departing from the spirit and scope of the invention.

Referring to FIGS. 15A-B and 16A-D, an outer section 44 of the male component B2 includes a cavity (not shown) for receiving an inner end 27 of the upper frame member first section 23, which can be fixedly secured within the cavity by an adhesive, a fastener, form fit or any combination thereof. An opposing inner section 42 of the male component B2 includes an inner projection B21 having an elongated slot B22 having a first end 22 and a second end 24. The elongated slot B22 extends through the width of the inner projection B21. The height of the elongated slot B22 increases slightly along the length of the elongated slot B22 from the second end 24 to the first end 22. The inner projection B21 further includes an engaging extension B24 extending outward towards the female component B1. Referring to FIG. 15B, the male component B2 includes a protrusion or outer projection 45 on each outer side surface between the outer section 44 and the inner section 42. The male component also includes a hook 49 to provide a means for attaching the cover 5 to the upper frame members 21.

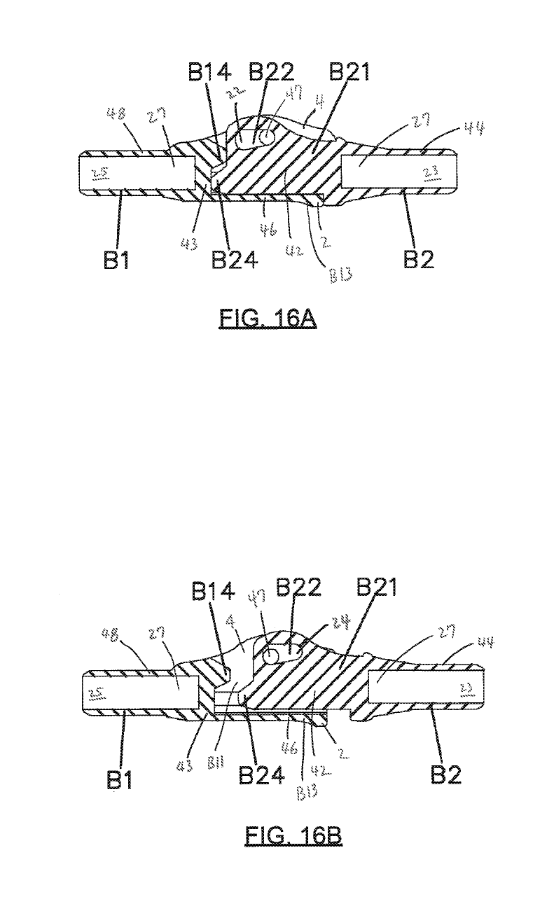

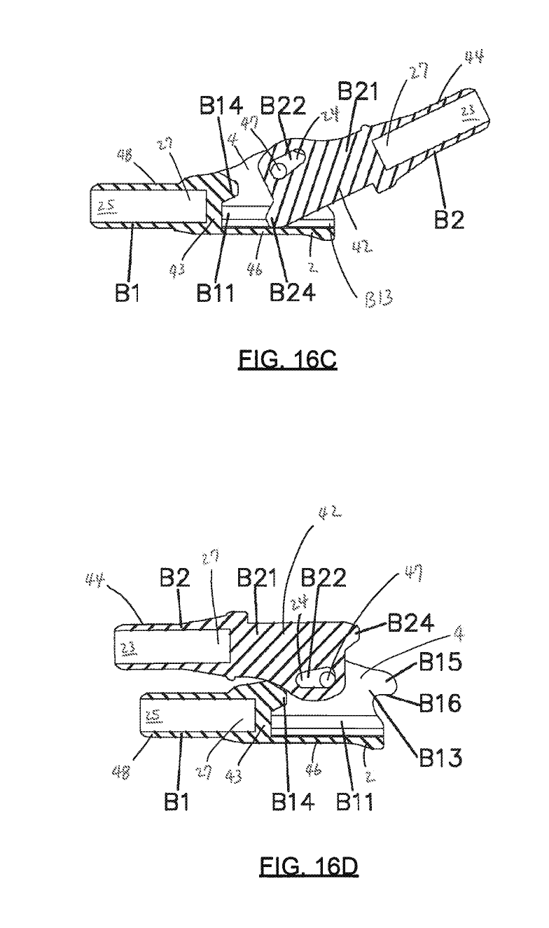

Referring again to 15A-B and 16A-D, an outer section 48 of the female component B1 includes a cavity (not shown) for fixedly receiving an inner end 27 of the upper frame member second section 25, which can be fixedly secured within the cavity by an adhesive, a fastener, form fit or any combination thereof. An opposing inner section 46 of the female component B1 includes a housing B13 having an upper portion 2 and two opposing side portions 4 extending downward from the upper portion 2 to form an opening B11 for receiving the inner projection B21 of the male component B2. The housing B13 also includes an inner ridge B14 extending from a back wall of the inner section 43 toward the male component B2, to form an engagement area between the inner ridge B14 and the housing upper portion 2. Referring to FIG. 16D, the inner section of the female component 46 also includes an outer ridge B15 which provides an engaging surface B16 for securely engaging the outer projection of the male component 45 when the first pivotal coupling member 41 is in a locked configuration as shown in FIG. 15A. The female and male components B1, B2 are pivotally coupled together by a fastener 47, such as a screw, metal pin, rivet or the like, which extends from each housing side portion 4 and through the elongated slot B22. The diameter of the fastener 47 is substantially similar to the height of the elongated slot B22 at the second end 24 of the elongated slot B22. One skilled in the art will also recognize that the female and male components B1, B2 are interchangeable such that the male component B2 could connect with the second section 25 and the female component B1 could connect with the first section 23.

Referring to FIGS. 15A and 16A, in the locked state, the first and second sections of each upper frame member 23, 25 are substantially aligned and the female and male components B1, B2 of the first coupling member 41 are engaged and pushed toward each other. The male component B2 is shifted toward the female component B1 such that the position of the fastener 47 within the elongated slot B22 is toward the second end 24 or the outer section of the male component 44 where the height of the elongated slot B22 is substantially similar to the diameter of the fastener 47, thereby forming a frictional engagement. The male engaging extension B24 engages the back wall of the female component inner section 43 between the inner ridge B14 and the housing upper portion 2 and is also secured by frictional engagement. The male outer projection 45 also engages the female engaging surface B16 between the outer ridge B15 and the housing upper portion 2 and is further secured by frictional engagement.

Referring to FIGS. 15B and 16B-D, the female and male components B1, B2 are unlocked by pulling the upper frame first and second sections 23, 25 away from each other. The engagement points described above are disengaged and the male component B2 is shifted away from the female component B1 such that the position of the fastener 47 within the elongated slot B22 is toward the first end 22 or the inner section of the male component 42, as shown in FIG. 16B, where the height of the slot B22 is slightly larger than that of the width at the second end 24 of the slot B22. The upper frame member first section 23 (simultaneously with the male component B2) is then pivoted inward (toward the cover 5) 180 degrees until the female and male components B1, B2 and first and second sections 23, 25 are substantially parallel to each other as shown in FIGS. 9, 10 and 16D.

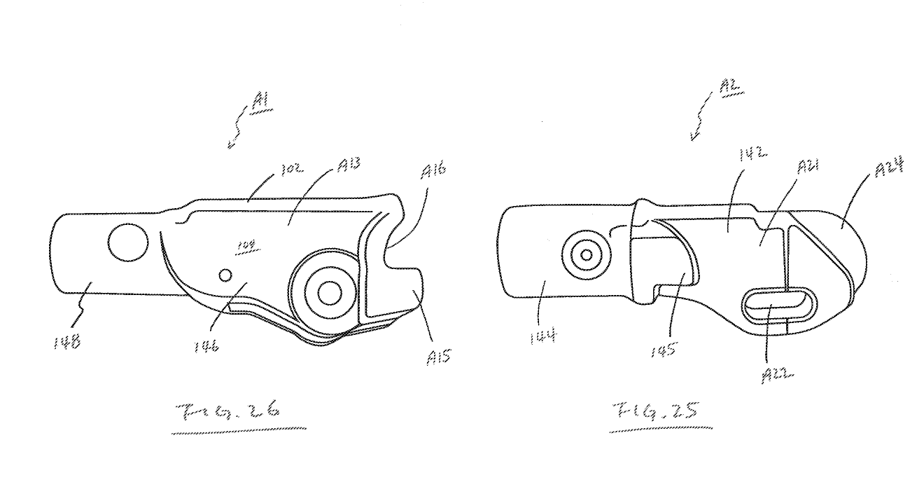

Referring to FIGS. 17-26, an alternative, preferred embodiment of the lockable first pivotal coupling member or connector device 141 is shown. The connector device 141 includes a female component A1 and a male component A2. The female and male components A1, A2 are preferably formed of a tough, molded plastic but can also be constructed with other light-weight high-strength materials and by other methods without departing from the spirit and scope of the present invention.

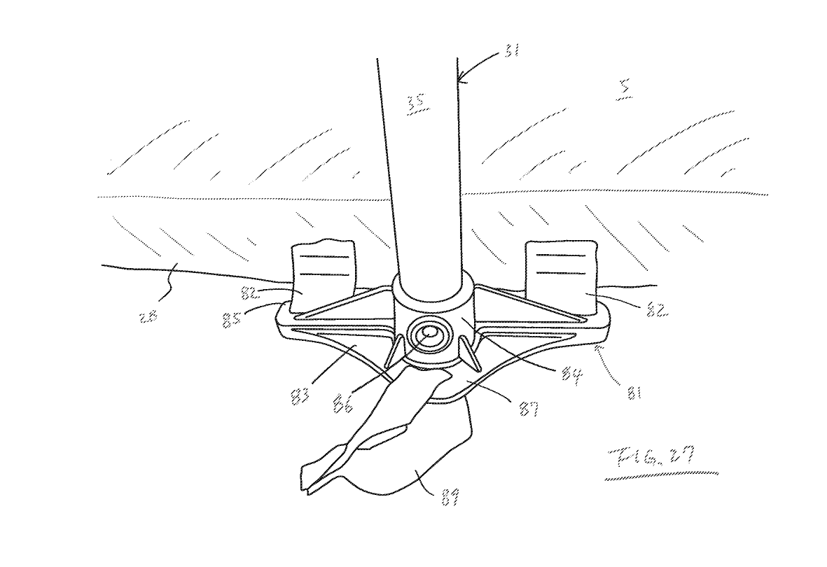

Referring to FIGS. 17-25, an outer section 144 of the male component A2 includes a cavity (not shown) for receiving an inner end 27 of the upper frame member first section 23, which is fixedly secured within the cavity by a fastener 147 but other means such as an adhesive, form fit or any combination thereof could be used. An opposing inner section 142 of the male component A2 includes an inner projection A21 having an elongated slot A22 having a first end 22 and a second end 24. The elongated slot A22 extends through the width of the inner projection A21. The height of the elongated slot A22 is constant throughout the length of the slot A22 and is substantially similar to the diameter of the fastener 47. The inner projection A21 further includes an engaging extension A24 having a cammed outer surface extending axially from a center portion of the inner projection A22 towards the female component A1 as shown in FIG. 25. The male component A2 also includes a protrusion or outer projection 145 on each outer side surface between the outer section 144 and the inner section 142.

Referring to 17-24 and 26, an outer section 148 of the female component A1 includes a cavity (not shown) for fixedly receiving an inner end 27 of the upper frame member second section 25, which is fixedly secured within the cavity by a fastener 147 but other means such as an adhesive, form fit or any combination thereof could be used. An opposing inner section 146 of the female component A1 includes a housing A13 having an upper portion 102 and two opposing side portions 104 extending downward from the upper portion 102 to form an opening A11 for receiving the inner projection A21 of the male component A2. The female component inner section 146 also includes an outer ridge A15 on outer sides of a distal end of the inner section 146 which provides an engaging surface A16, as shown in FIGS. 17, 21 and 26. The profile of the engaging surface A16 is substantially similar to the profile of the male component outer projection 145 such that when the connector device 141 is in a locked state, the outer projections 145 and engaging surface A16 are securely frictionally engaged as shown in FIG. 17. The housing upper portion 102 also includes an opening (not shown) for receiving a movable engaging member or push button assembly 10.

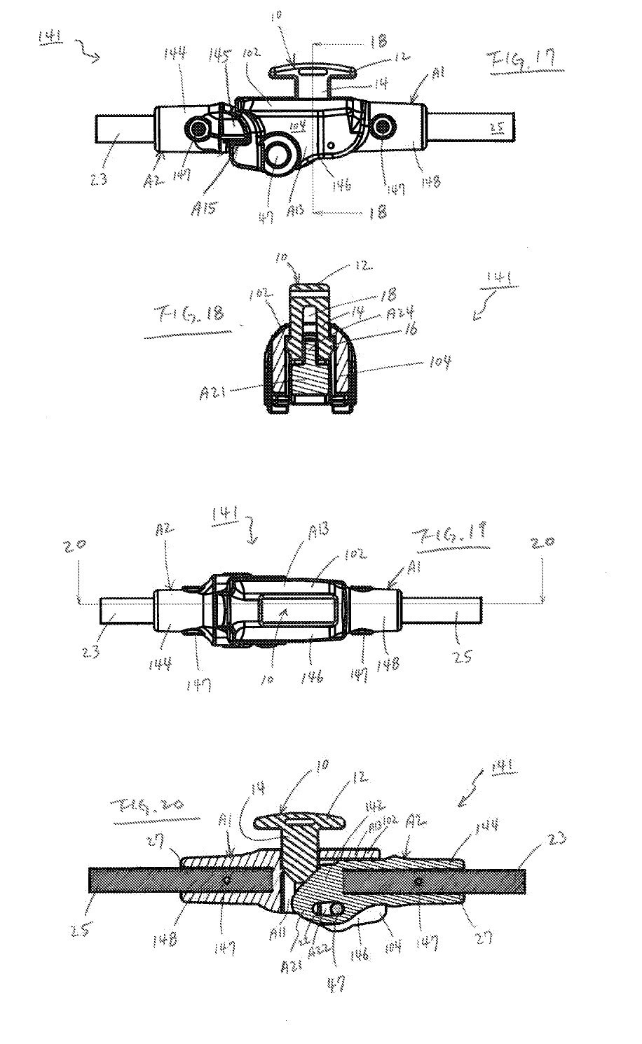

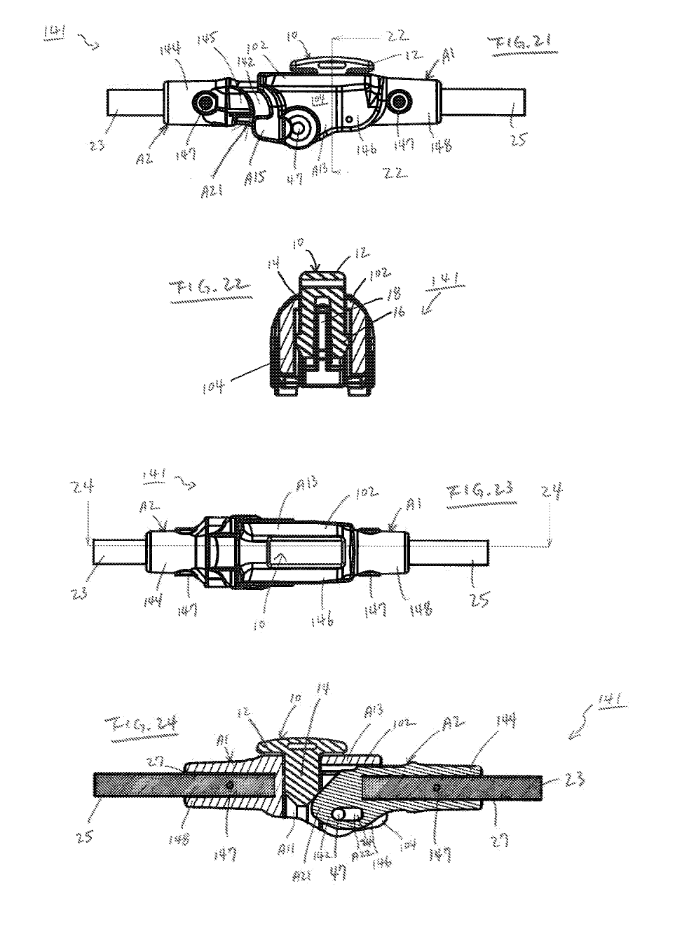

Referring to FIGS. 18 and 22, the push button assembly 10 includes a push button portion 12 and a pair of spaced apart extensions 14 extending downward from each side of the push button portion 12. The spaced apart extensions 14 form a channel 18 having a width substantially similar to the width of the engaging extension A24 of the male component A2. A lower portion of each extension 14 includes a detent 16 extending from outer sides of the extensions 14. Referring to FIGS. 20 and 24, a lower edge of each extension 14 is formed at an angle corresponding to the angle of the outer edge of the male component inner projection A21 to provide smooth engagement when the push button portion 12 is engaged to lock and unlock the female and male components A1, A2, as described below.

Referring to FIGS. 20 and 24, the female and male components A1, A2 are pivotally coupled by a fastener 47, such as a screw, metal pin, rivet or the like, which extends from each housing side portion 104 and the elongated slot A22. One skilled in the art will also recognize that the female and male components A1, A2 are interchangeable such that the male component A2 could connect with the second section 25 and the female component A1 could connect with the first section 23.

In operation, referring to FIGS. 17-20, in the locked state, the first and second sections of each upper frame member 23, 25 are substantially aligned and the female and male components A1, A2 of the connector device 141 are engaged and pushed toward each other. The male component A2 is shifted toward the female component A1 such that the position of the fastener 47 within the elongated slot A22 is at a second end 24 closer to the outer section of the male component 144. Referring to FIG. 18, the male engaging extension A24 extends through the push button assembly channel 18 and engages the extensions of the push button assembly 14, thereby forming a secure frictional engagement. The upward movement of the push button assembly 10 is limited by the detents 16 which engage an inner surface of the housing top portion 102. The male outer projection 145 also engages the female engaging surface A16 between the outer ridge A15 and the housing upper portion 102 and is further secured by frictional engagement, as shown in FIG. 17.

Referring to FIGS. 21-24, the female and male components A1, A2 are unlocked by pulling the upper frame first and second sections 23, 25 away from each other or by pressing down on the push button portion of the push button assembly 12. The engagement points described above are disengaged and the male component A2 is shifted away from the female component A1 such that the position of the fastener 47 within the elongated slot A22 is at the first end 22 or toward the inner section of the male component 142 as shown in FIG. 24. The upper frame first section 23, along with the male component A2 is then pivoted inward (toward the cover 5) 180 degrees until the female and male components A1, A2 and first and second sections 23, 25 are substantially parallel to each other as shown, for example, in FIGS. 9, 10 and 16D.

One of ordinary skill in the art will recognize that modifications could be made to the first pivotal coupling members 41, 141. For example, the coupling members 41, 141 could include additional hooks or an aperture extending through the coupling members 41, 141 to provide a means for attaching the cover 5 or other accessories.

Referring to FIGS. 7-10, each side frame member 31 includes a first pole section 33 and a second pole section 35, and each section 33, 35 has an inner end 37 and an outer end 39. In the preferred embodiment, each section 33, 35 is a substantially hollow, tubular pole constructed of steel but other materials such as reinforced fiberglass or any high-strength, light-weight material could be used. The first section outer end 39 of each side frame member 31 is pivotally connected to a corresponding outer end 29 of the upper frame member 21 by a second pivotal coupling member 51.

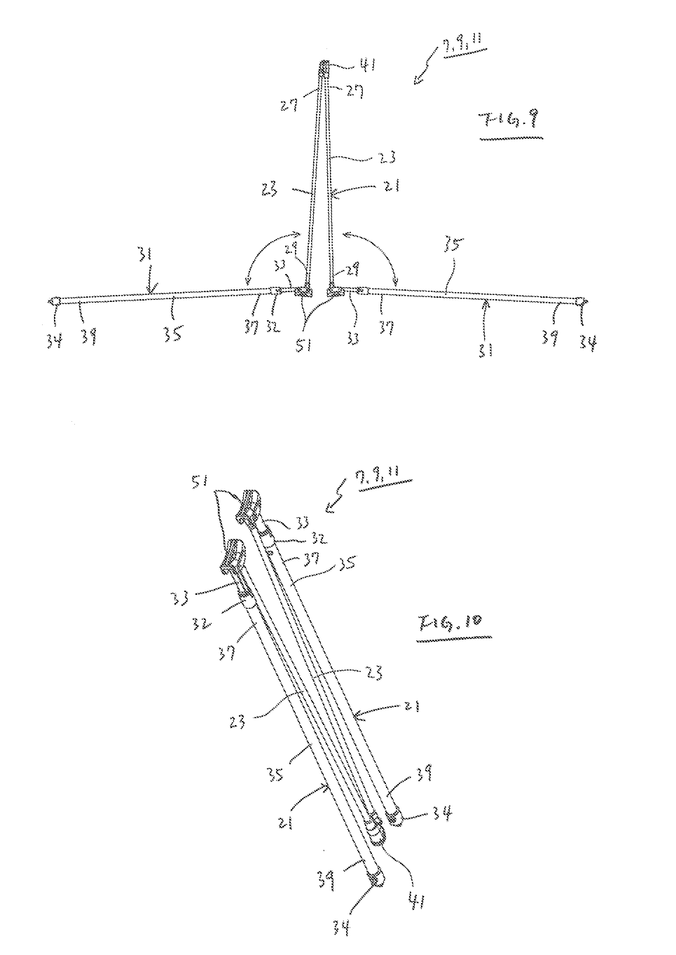

Referring to FIG. 14, in the preferred embodiment, the second pivotal coupling member 51 includes a U-shaped casing 53 having an opening (not shown) along an outer side 56 for receiving an outer end 29 of each section 23, 25 of the upper frame member 21 on one end and an outer end 39 of each first section 33 of the side frame member 31 on another end. The width of the opening of the casing 53 is constant throughout the opening and is substantially similar to the diameter of the side frame member first section 33. In the preferred embodiment, a cap 55 having a protrusion 57 on opposing sides is fixedly attached to the upper frame member outer end 29 to accommodate for the smaller diameter of fiberglass poles of the upper frame member first and second sections 23, 25. The outer diameter of the cap 55 measured from the outer surfaces of the protrusions 57 is substantially similar to the width of the opening of the casing 53. Material costs are reduced by utilizing protrusions 57 to increase the diameter of the upper frame member outer ends 29, instead of using a cap having a constant larger diameter throughout the cap. The cap 55 and the outer end of each upper frame member section 29 are attached by form fit and adhesive but other means such as a fastener could be used for the attachment. The cap 55 of the upper frame member first section outer end 29 and the side frame member first section outer end 39 are attached to the casing 53 by a fastener 59 for pivotal engagement. The casing 53 and cap 55 are preferably formed of a tough, molded plastic but can also be constructed with other light-weight, high-strength materials and by other methods without departing from the scope of the invention. In the preferred embodiment, the fastener 59 is a metal screw but other types of fasteners such as a metal pin or rivet could be used. The casing 53 further includes a hook 52 extending longitudinally from each end of the casing 53 along an inner side 54. The hook 52 faces inward towards the cover 5 and is used as an attaching means for the cover 5. The casing inner side 54 could also include an aperture extending through the casing 53 for attaching the cover 5. In operation, in the open configuration of the tent 1, the outer ends 29 (with cap 55) and 39 of each corresponding section 23 (or 25) and 33, respectively, is disposed within the opening of the casing 53 and is secured by frictional engagement between the protrusions 57 and an inner side surfaces of the casing 53, and the side frame member first section outer end 39 and the inner side surfaces of the casing 53. In the collapsed configuration, the outer ends 29 (with cap 55) and 39 are disengaged from the casing 53 and the corresponding sections 23 (or 25), 33 are pivoted outwardly through the opening of the casing 53 to a substantially parallel configuration as best shown in FIG. 10.

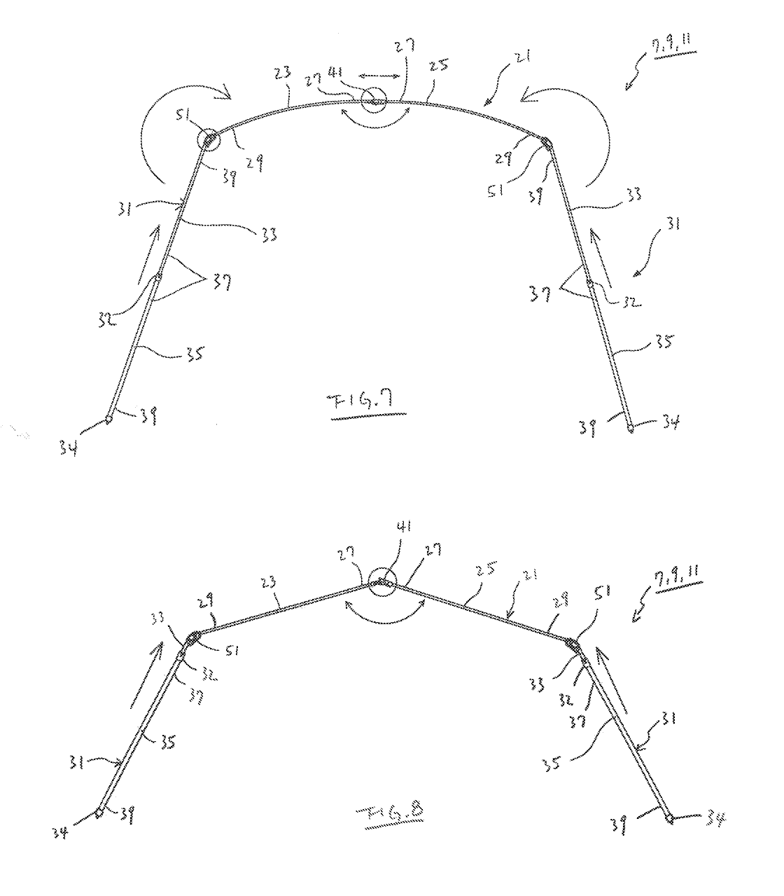

Referring again to FIGS. 7-10, the first and second sections 33, 35 of each side frame member 31 are slidingly coupled together. In the preferred embodiment, the inner diameter of the second section 35 is substantially similar to the outer diameter of the first section 33 such that the first section 33 is telescopically slidable within the second section 35. The inner end of the first section 33 is provided with a locking member 32. Each telescoping second section 35 includes a spring loaded detent pin (not shown) for indexing in apertures (not shown) provided in each corresponding first section 33 for locking the sections 33, 35 in an extended position as shown in FIG. 7, and depressing the detent pin to disengage the apertures to unlock and retract the second section 35 as shown in FIGS. 8-10. It is preferred that the length of the second section 33 is substantially similar to the length of the first section 33 such that when retracted substantially all of the first section 33 is stored within the second section 35. Each outer end 39 of the side frame second section 35 may also include an end cap 34 for engagement with a coupling extension 81 which is described in more detail below.

One of ordinary skill in the art will recognize that multiple spring loaded detent pin-aperture combinations could be included in each side frame member section 33, 35 such that the sections 33, 35 could be adjusted to different lengths. It will also be recognized that any other conventional means for connecting the side frame member sections 33, 35 could be used, including but not limited to other slidable and pivotal connections.

Referring to FIG. 11, an alternative embodiment of the outer frame members 7, 11 is shown. In this embodiment, the outer frame members 7, 11 are provided with a pair of auxiliary poles 131 for additional support to the overall structure of the foldable tent 1. Each auxiliary pole 131 is configured substantially similarly to the side frame members 31 as described above. That is, each auxiliary pole 131 includes first and second pole sections 133, 135 each having an inner end 137 and an outer end 139. The first and second sections 133, 135 are telescopically connected, and the outer ends 139 of each first section 133 are pivotally connected to each outer frame member 7, 11 at or near each corresponding side frame member first section 33 outer end 39. In the open configuration of the tent 1, each auxiliary pole 131 extends along a corner seam 13 bridging two side walls 8 and each second section 135 outer end 139 is coupled to a coupling extension 81 (described below) located at corresponding corners of the cover bottom section 28. To collapse the auxiliary poles 131, the auxiliary poles 131 are disengaged from the coupling extensions 81, each auxiliary pole 131 is collapsed as described above with respect to the side frame members 31 and are pivoted inwardly and aligned with corresponding side frame members 31.

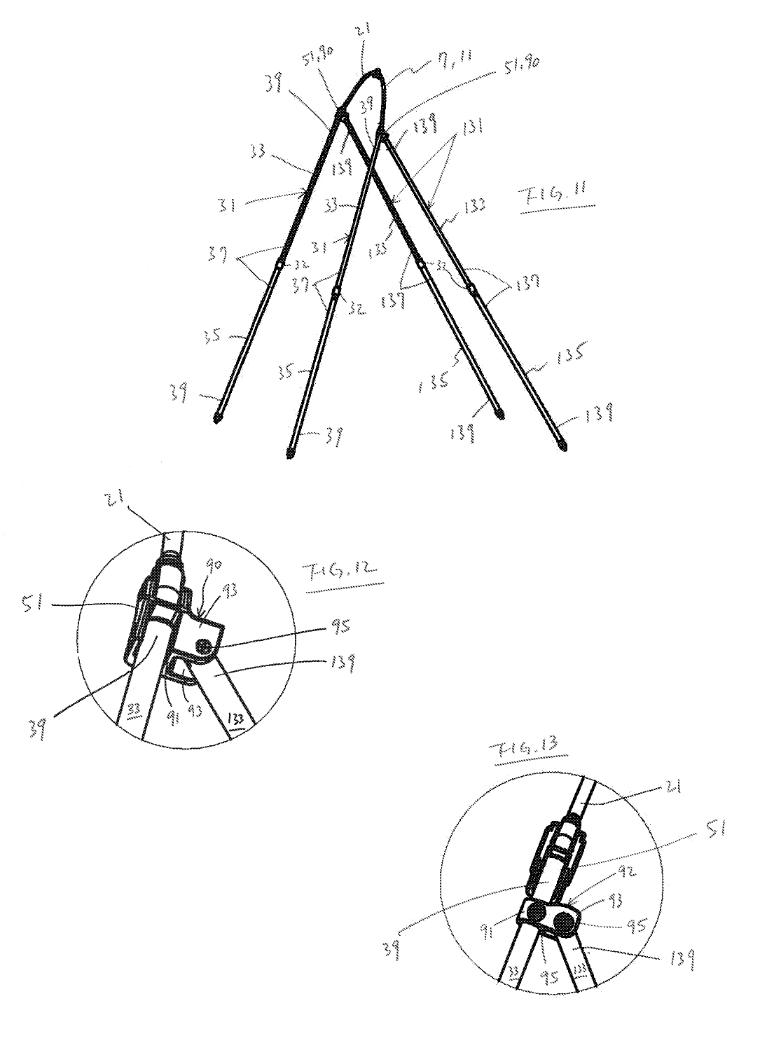

Referring to FIG. 12, to couple the auxiliary poles 131 to the outer frame members 7, 11, in one embodiment, a side portion of the second pivotal coupling member 51 includes a third pivotal coupling member or U-shaped connector 90 having a rear wall 91 and a pair of spaced apart side walls 93 extending outwardly to form a recess (not shown) for receiving the outer end 139 of the auxiliary pole first section 133. The U-shaped connector 90 is integral to the second pivotal coupling member 51 and is preferably formed of a tough, molded plastic but can also be constructed with other high-strength, light-weight materials and by other methods without departing from the scope of the invention. The outer end 139 of each auxiliary pole first section 133 is pivotally connected to the U-shaped connector 90 by a fastener 95 which extends through the auxiliary pole first section 133 and through each side wall 93. In the preferred embodiment, the fastener 95 is a metal screw but other types of fasteners such as a metal pin or a rivet could be used.

Referring to FIG. 13, in another embodiment of a third pivotal coupling member, the outer end 139 of each auxiliary pole first section 133 is pivotally connected to the side frame member first section 33 by an independent connector assembly 92. In this embodiment, the connector assembly 92 is substantially U-shaped and includes a curved rear wall 91 and a pair of spaced apart side walls 93 extending outwardly therefrom to form a recess (not shown) for receiving the outer end 39 of the side frame member first section 33 as well as the outer end 139 of the auxiliary pole first section 133. The connector assembly 92 is preferably formed of a tough, molded plastic but can also be constructed with other high-strength, light-weight materials and by other methods without departing from the scope of the invention. The outer end 39 of the side frame member first section 33 is disposed against the curved rear wall 91 and adjoining side wall portions 93, and is fixedly attached thereto by a fastener 95 which extends through the side frame member first section 33 and through each side wall 93. The outer end 139 of each auxiliary pole first section 133 is pivotally connected to the connector assembly 92 by a fastener 95 which extends through the auxiliary pole first section 133 and through each side wall 93. In the preferred embodiment, the fastener 95 is a metal screw but other types of fasteners such as a metal pin or a rivet could be used.

One of ordinary skill in the art will recognize that the number of frame members, the number of sections of each frame member, as well as the folding methods of the frame members could vary without departing from the spirit and scope of the invention. It is also possible to add further extensions and additional auxiliary poles to the frame members to provide more stability to the overall structure of the foldable tent.

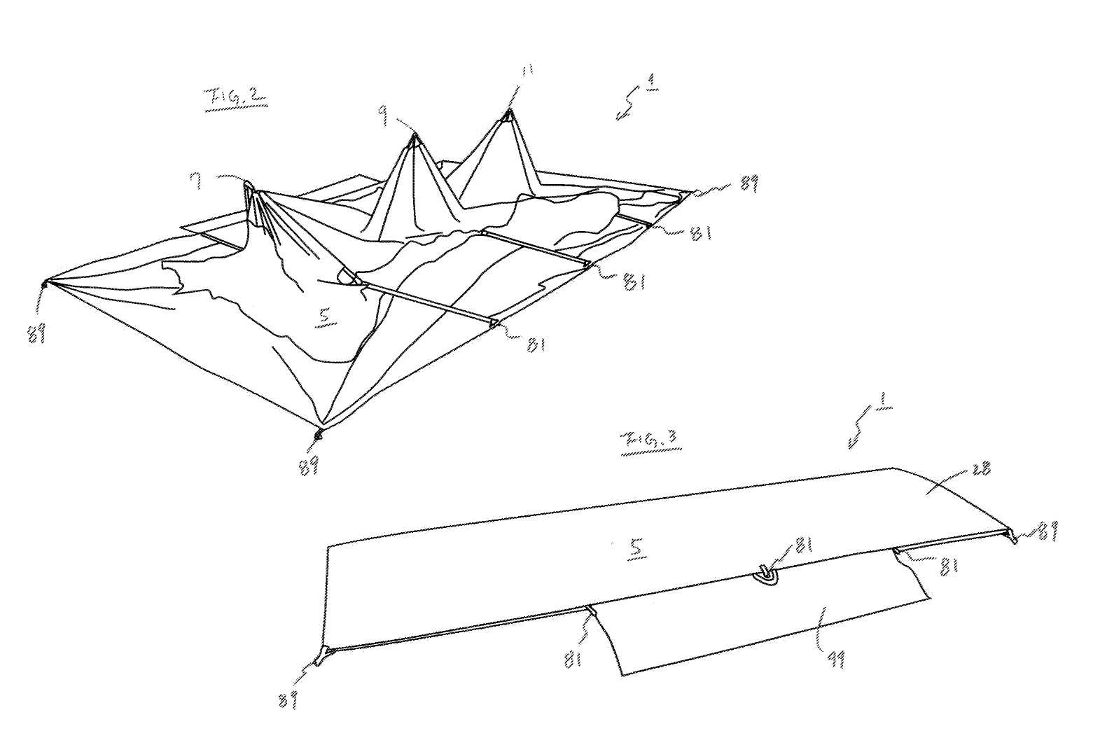

Referring to FIGS. 1-6, the cover 5 of the foldable tent 1 includes a plurality of cover members fixedly attached together by conventional sewing methods, to form an enclosed shelter having a top section 6, bottom section 28 and plurality of side sections 8. The side sections 8 include a plurality of vinyl and/or mesh windows and doors. The cover 5 includes an inner surface (not shown) and an outer surface 15. In the preferred embodiment, the cover 5 is water and flame resistant, and is a fabric constructed from materials such as cotton, polyester or nylon, or any combination thereof. Some or all of the cover 5 can also be constructed with heat reflecting material and other materials could be used for the cover 5, such as mesh fabric, without departing from the spirit and scope of the invention. In the preferred embodiment, the bottom section of the cover 28 extends further outward than the top section of the cover 6 such that the side sections of the cover 8 are formed on an incline. The incline ensures that any water or debris will not accumulate on the cover 5 and instead will travel toward the bottom of the tent 1 to the surface. The adjoining cover members form seams 13 throughout the cover 5 and additional seams 13 are formed from adjoining sections that form the windows and doors. A continuous flexible adhesive tape (not shown) is applied to the seams 13 on the inner surface of the cover 5 to prevent rain water, other liquids or debris from penetrating the cover 5 through the seams 13 from the outer surface 15. In the preferred embodiment, frame members 7, 9, 11 are generally aligned with the vertical seams 13 of the side sections of the cover 8 and the horizontal seams 13 of the top section of the cover 6. In the preferred embodiment, the top section of the cover 5 is attached to the upper frame members 21 by a plurality of sleeves 17 which are attached at the horizontal seams 13 of the top section of the cover 6 by conventional sewing methods. The sleeves 17 extend along the entire length of each upper frame member 21 except where the first pivotal coupling member 41, 141 is located. One of ordinary skill in the art will recognize that the sleeves could be replace by a plurality of hooks or other attachment means without departing from the spirit and scope of the invention. Other portions of the cover 5 could be attached to the frame assembly 3 by additional hooks or other attachment means as well. The cover 5 could also be provided with a plurality of attachment means, e.g., a string made of high-strength material, to attach to hooks or apertures provided on the first pivotal coupling member. In the preferred embodiment, the cover 5 also includes a door mat extension 99 shown in FIG. 3. One of ordinary skill will recognize that other components or accessories, such as a rain fly or any other modification to the inner and outer surfaces of the cover could be added to the foldable tent 1 of the present invention.

Referring to FIG. 27, the bottom portion of the cover 28 includes a plurality of coupling extensions 81 for further securing the frame assembly 3 to the cover 5. The bottom portion of the cover 28 is constructed of a tough, water resistant polyethylene material. The coupling extension 81 includes a housing portion 83, formed of a tough, molded plastic, having a substantially cylindrical extension or pole receiving member 84 extending upwardly for receiving the side frame member second section 35 outer end 39. The cylindrical extension 84 includes an aperture 86 for receiving a fastener for fixedly attaching the side frame member second section 35 outer end 39 to the coupling extension 81 directly or via the cap 34 of the second section outer end 39. The housing portion 83 also includes a pair spaced apart of slots (not shown) at an inner end of the housing portion 85, as well as a slot (not shown) at an outer end of the housing portion 87. An outer strap 89 formed of a woven nylon material is attached to the single slot at the outer end of the housing portion 85 to accommodate for stakes (not shown) to secure the tent 1 to a surface. An inner strap or connector 82 is coupled to each slot at the inner end of the housing portion 85 and is further coupled to the bottom portion of the cover 5 by conventional sewing methods. The multiple inner straps 82 prevent the coupling extension 81 from rotating during storage and transport, thereby eliminating any adjustments that may have to be made when erecting the tent 1. Referring to FIG. 1-6, each corner of the cover 19 also includes a strap 89 extending from the cover bottom portion 28 to accommodate for stakes (not shown) to secure the tent 1 to a surface. The corner straps 89 could be replaced by coupling extensions 81 to receive the auxiliary poles 131, if they are used with the outer frame members 7, 11 as shown in FIG. 11.

In operation, referring to FIGS. 1-10, the foldable tent 1 is erected by unfolding the cover 5 and frame assembly 3 as shown in FIGS. 2-6. Each corner of the cover 19 is extended until the cover bottom section 28 is fully expanded and taut, and stakes are applied to the straps 89 of each corner of the cover 19 to secure the cover 5 to a surface. Stakes can also be applied to the straps 89 of each coupling extension 81. Each frame member 7, 9, 11 is positioned in a substantially upright position as shown in FIGS. 2 and 8. The side frame member first section 33 is extended from the side frame member second section 35 and the two sections 33, 35 are locked in an extended configuration as shown in FIG. 7. The upper frame member first and second sections 23, 25 are aligned and pushed toward each other to lock the first pivotal coupling member 41 or 141 of the upper frame member 21 into a locked state as shown in FIG. 7, 15A, 17. Once the frame members 7, 9, 11 are extended and locked the top and side sections of the cover 6, 8 become taut due to the geometrical constraints of the overall configuration of the tent 1 as shown in FIG. 1. The cover 5 exerts a generally downward and inward force on the frame assembly 3 which aides in maintaining the tent 1 in the open configuration. Referring to FIG. 1, in the open configuration, the first pivotal coupling members 41 are aligned along a common first x-y plane and the second pivotal coupling members 51 on each side of the tent 1 are also aligned in common second and third x-y planes, respectively.

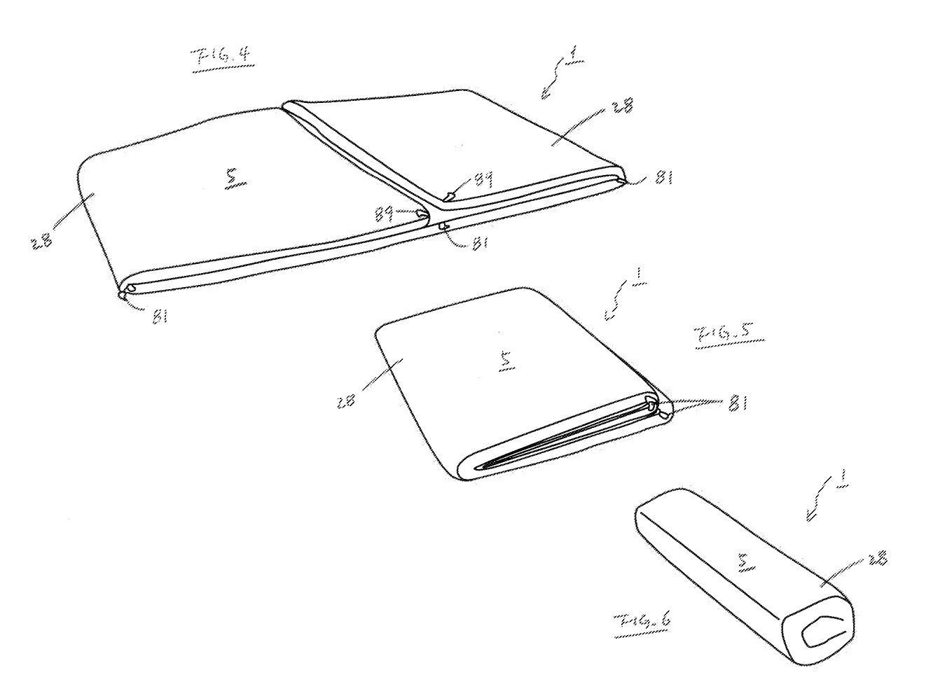

Referring to again to FIGS. 1-10, the tent 1 is folded in reverse order as described above culminating in a compact folded configuration as shown in FIG. 6. That is, the frame members 7, 9, 11 are collapsed and the cover 5 is folded in half along a central longitudinal axis as shown in FIG. 3, as each frame member 7, 9, 11 is collapsed to a fully collapsed state as shown in FIG. 10. At this time, each collapsed frame member 7, 9, 11 extends across the width of the outer surface of the cover 15. The cover 5 is then folded along axes formed by the collapsed outer frame members 7, 11 as shown in FIG. 4, and folded again along an axis formed by the collapsed inner frame member 9 as shown in FIG. 5. The cover is then rolled into a compact bundle as shown in FIG. 6. These systematic folding steps allow the tent 1 to be consistently folded into a tight, compact bundle to minimize storage space.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A foldable tent comprising a frame assembly and a cover fixed to the frame assembly such that an enclosed area is provided when the tent is erected in an open configuration, and the frame assembly and cover are collectively compactly collapsed and folded together in a folded configuration of the tent,
the frame assembly comprising a plurality of independent frame members detached from each other, each frame member having an upper frame member and a pair of side frame members, each upper and side frame members having first and second sections, each first and second section having an inner end and an outer end, the inner ends of each upper frame member pivotally coupled together by a lockable first pivotal coupling member, the outer ends of each upper frame member each pivotally coupled to an outer end of a corresponding side frame member first section by a second pivotal coupling member, the first and second sections of each side frame member coupled together, and
the cover comprising a plurality of adjoining cover members fixedly coupled together to form an enclosure having an inner surface and an outer surface, the cover having a top section, a plurality of side sections and a bottom section, the adjoining cover members forming a plurality of seams.

2. The foldable tent of claim 1, wherein the plurality of frame members comprises at least one inner frame member and a plurality of outer frame members surrounding the at least one inner frame member such that the first pivotal coupling members are substantially aligned in a first plane and the second pivotal coupling members on each corresponding side frame member are substantially aligned in second and third planes, respectively.

3. The foldable tent of claim 2, wherein the outermost frame members comprise a plurality of auxiliary poles pivotally coupled to each side frame member.

4. The foldable tent of claim 3, wherein each auxiliary pole comprises a plurality of pole sections slidingly coupled together.

5. The foldable tent of claim 1, wherein the outer ends of the second sections of the side frame members are each coupled to the bottom section of the cover by a coupling extension.

6. The foldable tent of claim 5, wherein the coupling extension comprises a plurality of connectors fixedly coupled to the bottom section of the cover.

7. The foldable tent of claim 5, wherein the coupling extension comprises a pole receiving member for receiving the outer end of the side frame member second section.

8. The foldable tent of claim 1, wherein each of the plurality of frame members are coupled to the top section of the cover by a plurality of sleeves.

9. The foldable tent of claim 1, wherein each of the plurality of frame members are substantially U-shaped.

10. The foldable tent of claim 1, wherein each frame member is aligned with at least one of the plurality of seams.

11. A foldable tent comprising a frame assembly and a cover permanently fixed to the frame assembly,
the frame assembly comprising a plurality of independent frame members detached from each other, each frame member having a plurality of sections coupled together such that each section is collapsible from an extended state in an open configuration of the tent to a collapsed state in a folded configuration of the tent;
wherein each frame member is independently coupled to the cover such that an enclosed area is provided when the tent is erected in the open configuration, and the frame members and cover are collectively compactly collapsed and folded together when the tent is in the folded configuration.

12. The foldable tent of claim 11, wherein each frame member comprises an upper frame member and a pair of side frame members, each upper and side frame members having first and second sections, each first and second section having an inner end and an outer end, the inner ends of the first and second sections of each upper frame member pivotally coupled together by a first pivotal coupling member.

13. The foldable tent of claim 12, wherein each outer end of the first and second sections of each upper frame member is pivotally coupled to an outer end of a corresponding side frame member first section by a second pivotal coupling member.

14. The foldable tent of claim 13, wherein the plurality of frame members comprises at least one inner frame member and a plurality of outer frame members surrounding the at least one inner frame member such that the first pivotal coupling members are substantially aligned in a first plane and the second pivotal coupling members on each corresponding side frame member are substantially aligned in second and third planes, respectively.

15. The foldable tent of claim 14, further comprising outwardly extending auxiliary poles pivotally coupled to each of the outermost frame members.

16. The foldable tent of claim 11, wherein the cover comprises a plurality of adjoining cover members fixedly coupled together to form an enclosure having an inner surface and an outer surface, the cover having a top section, a plurality of side sections and a bottom section, the adjoining cover members forming a plurality of seams.

17. The foldable tent of claim 16, wherein the outer ends of the second sections of the side frame members are each coupled to the bottom section of the cover by a coupling extension.

18. The foldable tent of claim 17, wherein the coupling extension comprises a plurality of connectors fixedly coupled to the bottom section of the cover.

19. The foldable tent of claim 17, wherein the coupling extension comprises a pole receiving member for receiving the outer end of the side frame member second section.

20. A connector device for retaining a pair of pivotally connected tent poles, the connector device comprising male and female components coupled to one another so as to permit positioning of the poles in a substantially aligned configuration or in a substantially parallel configuration with respect to each pole,
the male component comprising an outer section having a first cavity for securely receiving an end of one of the poles and an opposing inner section having an inner projection, the inner projection comprising an elongated slot having a first end and a second end, the elongated slot extending through the inner projection, and an engaging extension extending axially from a center portion of the inner projection; and
the female component comprising an outer section having a second cavity for securely receiving an end of the other one of the poles and an opposing inner section having a housing for receiving the inner projection of the male component, the housing having an upper portion and two opposing side portions extending downward from the upper portion, the male and female components pivotally connected together by a fastener extending through the elongated slot of the male component and fixedly coupled to the opposing side portions of the housing of the female component, an upper portion of the housing having an opening for receiving a movable engaging member, a lower section of the engaging member comprising a pair of spaced apart extensions thereby forming a channel therebetween;
wherein in a locked state the engaging extension of the male component is fixedly secured within the channel of the engaging member of the female component such that the male and female components are maintained in the substantially aligned configuration, and in an unlocked state the engaging extension of the male component disengages the engaging member of the female component to permit displacement and pivoting up to 180 degrees of the male component relative to the female component.
